(19) United States
(12) Patent Application Publication
(10) Pub. No.: US 2006/0287896 A1
(43) Pub. Date: Dec. 21, 2006

(54) Method for providing crop insurance for a crop associated with a defined attribute

(75) Inventors: Shawn James McComb, Algonquin, IL (US); George Bailey Muehlbach, Fort Collins, CO (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/373,382

(22) Filed: Mar. 10, 2006

Related U.S. Application Data
(60) Provisional application No. 60/691,109, filed on Jun. 16, 2005.

(51) Int. Cl. G06Q 40/00

(52) U.S. Cl. 705/4

(57) ABSTRACT

A method for managing the risk of growing a crop having a defined attribute. A grower is evaluated to determine whether the grower is associated with a qualified geographic zone or zones for growing a particular crop with a defined attribute. A performance predictor estimates or predicts a grower performance for the particular grower consistent with the geographic zone and desired crop attribute. An evaluator determines if the grower as a qualified grower for the particular crop with the defined attribute based on the estimated grower performance meeting or exceeding a threshold value. The evaluator designates the qualified grower as eligible for an attribute endorsement to at least one of a yield-based crop insurance and a revenue-based crop insurance.

This document (including all drawings) claims priority based on U.S. provisional application Ser. No. 60/691,109, filed Jun. 16, 2005, and entitled METHOD FOR PROVIDING CROP INSURANCE FOR A CROP ASSOCIATED WITH A DEFINED ATTRIBUTE under 35 U.S.C. 119(e).

### FIELD OF THE INVENTION

This invention relates to a method of providing crop insurance for a crop associated with a defined attribute, an insurance product for managing the risk associated with crops with defined attributes, and a risk management system.

### BACKGROUND OF THE INVENTION

Farmers use crop insurance to reduce or manage various risks associated with growing crops. Such risks include crop loss or damage caused by weather, hail, drought, frost damage, insects, or disease, for instance. A farmer or grower may desire to grow a crop associated with a particular defined attribute that potentially qualifies for a premium over similar commodity crops, agricultural products, or derivatives thereof. The particular attribute may be associated with the genetic composition of the crop, certain management practices of the grower, or both. However, many standard crop insurance policies do not differentiate between commodity crops and crops associated with particular attributes. Accordingly, farmers have a need for crop insurance to cover the risk of growing crops associated with particular attributes.

### SUMMARY OF THE INVENTION

A method for providing crop insurance for a crop associated with a defined attribute facilitates insuring crops that are distinct with respect to a commodity crop or another reference crop. A grower is evaluated to determine whether the grower is associated with a qualified geographic zone or zones for growing a particular crop associated with a defined attribute. A performance predictor estimates or predicts a grower performance (e.g., yield) for the particular grower consistent with the geographic zone, the particular crop, and the desired crop attribute. An evaluator determines if the grower is a qualified grower for the particular crop with the defined attribute based on the estimated grower performance (e.g., yield) meeting or exceeding a threshold value. The evaluator designates the qualified grower as eligible for the crop insurance (or an endorsement) associated with a defined attribute or as eligible for crop insurance for a certain premium level or range.

### BRIEF DESCRIPTION OF THE DRAWINGS

FIG. 1 is a block diagram of a risk management system for providing crop insurance associated with a defined attribute.

FIG. 2 is a flow chart of one embodiment of a method for providing crop insurance for a defined attribute in accordance with the invention.

FIG. 3 is a flow chart of another embodiment of a method for providing crop insurance for a defined attribute in accordance with the invention.

FIG. 4 is a flow chart of yet another embodiment of a method for providing crop insurance for a defined attribute in accordance with the invention.

FIG. 5 is a flow chart of still another embodiment of a method for providing crop insurance for a defined attribute in accordance with the invention.

FIG. 6 is a flow chart an embodiment of a method for providing crop insurance for a defined attribute based on a rating or variance level of a particular grower.

FIG. 7 is a graph of first yield distribution of a first grower for a particular crop and a second yield distribution of a second grower for a particular crop or group of growers for the particular crop.

FIG. 8A through FIG. 8D, inclusive, are graphs that show variance reduction in the yield distribution of a grower by applying various techniques.

FIG. 9 is an illustrative example of a price versus yield model for a grower to illustrate the targeted risk coverage of attribute insurance.

### DESCRIPTION OF THE PREFERRED EMBODIMENT

A crop may include, any type of edible or inedible agricultural product, grain, oilseed, fiber, fruit, nut, seed, or vegetable or any other material produced by a genetically modified plant or non-genetically modified plant. A defined attribute may comprise one or more of the following characteristics of any crop: organic, organically grown, high oil, high protein, high starch, waxy, highly fermentable, color, grade, classification, weight, nutritionally enhanced, pest resistant, herbicide resistant, pesticide resistant, fungicide resistant, drought tolerant, freeze tolerant, mildew resistant, bacterial resistant, disease resistant, non-genetically modified, genetically modified, genetically altered protein content, genetically altered enzyme content, genetically altered sugar content, genetically altered starch content, high protein, yield enhanced, pharmaceutical traits, precursors or ingredients, pharmaceutical properties, medicinal properties, genetically resistant to cross-pollination (e.g., a teosinte gene cluster introduced into corn deoxyribonucleic (DNA) acid) from neighboring genetically modified crops, and any other crop attributes.

A defined attribute may represent any plant trait associated with a crop, an agricultural product derived from the crop, or both. Further, the defined attribute may comprise a characteristic that is associated with a particular level or range of levels of any of the following: a plant trait, protein, oil, starch in plant material (e.g., harvested grain, fiber or oilseed). For example, soy meal having a certain characteristic (e.g., a minimum percent protein content by volume or weight) may be derived from soybeans as the crop. The defined attribute may be, but need not be, defined with respect to a corresponding attribute of a commodity crop, an agricultural product derived from a commodity crop, or another reference.

Although any generally accepted grading standard (e.g., a standard adopted by the Chicago Board of Trade or elsewhere within the marketplace) may be used to define a commodity crop, the generally accepted grading standards may not address a defined attribute or another particular characteristic of interest (e.g., corn with a particular protein profile, starch content, or sugar content). Accordingly, the defined attributes may be defined in accordance with one or more of the following items: (1) reference genetic profile (e.g., for pharmaceutical crops or other genetically modified crops), (2) identity of a gene cluster or sequence inserted into plant deoxyribonucleic acid (DNA), (3) a characteristic of a plant resulting from the expression of a genetic trait, or (4) reference growing practices (e.g., for organic crops or specialty crops).

In the U.S., the government (e.g., Federal Grain Inspection Service) establishes grain standards under the United States Grain Standards Act that are suitable for defining commodity grains. The detailed grain standards are currently set forth in 7 C.F.R. § 810.101 through § 810.2205. Under U.S. grain standards, corn is divided into three classes: yellow, white and mixed; each class may be associated with a grade ranging from U.S. No. 1 to U.S. No. 5. The grades of corn are generally based on minimum test weight per bushel, percentage of heat damage, percentage of broken kernels, and amount of foreign material. Similarly, in the U.S. for commodity soybeans the applicable soybean grades (e.g., U.S. No. 1) are generally based on test weight, heat damage, foreign material content, total damage and splits (e.g., broken seeds).

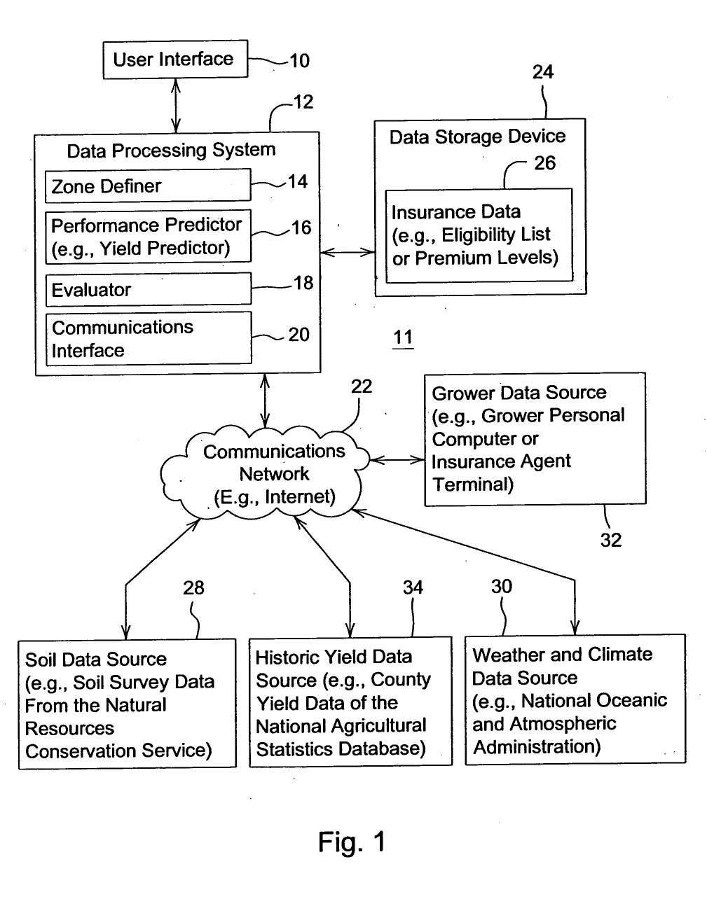

In FIG. 1, the risk management system 11 comprises a data processing system 12 coupled to a user interface 10 and a data storage device 24. The risk management system 11 supports the provision of crop insurance or an endorsement for a crop insurance associated with a defined attribute. In one embodiment, the data processing system 12 may communicate with one or more of the following via a communications network 22 (e.g., the Internet): a soil data source 28, a historic yield data source, a weather and climate data source 30, and a grower data source 32. Alternately, the user may input data via the user interface 10, where the inputted data is equivalent to, similar to, or distinct from that available via any data source accessible over the communications network 22.

The user interface 10 may comprise any device that enables a user to enter or input data directly or indirectly into the data processing system 12. The user interface 10 may comprise a keyboard, a keypad, a pointing device (e.g., an electronic mouse), a display, an optical drive, a magnetic disk drive, a magnetic reader, or another device for inputting or outputting data.

The data processing system 12 comprises a zone definer 14, a performance predictor 16, an evaluator 18, and a communications interface 20. The user may enter a particular crop identifier, or a particular crop associated with a defined attribute, via the user interface 10. The crop identifier or defined attribute may identify the genetic characteristics or genetic profile of the crop or the user may enter the genetic specifications associated with the particular crop.

The zone definer 14 defines suitable zones for the particular crop (with a defined attribute) based on at least one of soil data, weather data, climate data, other environmental data, genetic characteristics, and the crop identifier. The zone definer 14 may define the boundaries of each zone or points (e.g., coordinates) that lie on the boundaries of each zone. Alternately, each zone may be defined by a group of cells (e.g., polygonal cells). A county or a grower's field may be subdivided into one or more zones (e.g., if the soil or weather materially varies over the county or the grower's field).

The performance predictor 16 may estimate the performance (e.g., yield, attribute expression, purity of the defined attribute, or concentration of the defined attribute) of the particular crop with a defined attribute. For example, the yield of corn may be expressed in terms of predicted or estimated bushels per land unit (e.g., acre) or range thereof. The performance predictor 16 may consider one or more of the following to estimate the performance of a particular crop associated with a defined attribute: the defined zone or zones for the corresponding particular crop, the crop identifier, genetic profile, or genetic characteristics of the particular crop, historic climate data, historic weather data, soil data, genetic factors for the particular crop, environmental factors for the zone or zones, historic performance (e.g., yield) of the particular grower or geographic area, and crop management factors (e.g., irrigation and application of crop inputs) associated with the particular grower.

The evaluator 18 determines whether estimated performance (e.g., yield) of the particular grower meets or exceeds a threshold performance (e.g., a reference or benchmark yield). In a first example, the threshold performance is based on the yield of a substantially similar crop to the particular crop in a zone that is the equivalent of or substantially the same as the particular grower's zone. In a second example, the threshold performance is based on the yield of a substantially similar crop to the particular crop in a county or other geographic region that includes or encompasses the zone. In a third example, the threshold performance may comprise a coefficient of variation (e.g., a ratio of standard deviation of the yield to mean yield) or another benchmark that considers both variance and the mean performance of the grower within a season or over multiple growing seasons. In a fourth example, the threshold performance is based on the historic performance or yield associated with the particular crop growing in a suitable zone or zones for the particular crop. If the evaluator 18 determines that the estimated performance of the particular grower meets or exceeds the threshold performance, the grower may add that grower to an eligibility list of growers eligible for attribute crop insurance or growers eligible for crop insurance at a certain range of corresponding premium levels. The eligibility list, premium levels, grower variance ratings for growing particular crops, or other insurance data 26 is stored in a data storage device 24.

The communications interface 20 manages communications via the communications network 22. Although the soil data source 28, weather and climate data source 30, historic yield data source 34, and the grower data source 32 are shown as communicating to the data processing system 12 through the communications network 22, any soil data, weather data, climate data, historic yield data, or grower data may be inputted via the user interface 10. That is, the user may input soil data, weather and climate data, historic yield data, grower data, and other input data into the data processing system 12, as opposed to obtaining such input data via the communications network 22 (e.g., Internet).

In one embodiment, the soil data source 28 comprises a server, a database management system, or another data processing system. The soil data source 28 makes available or provides any soil survey data or other soil data from a governmental or nongovernmental entity. For example, the soil survey data may comprise the soil survey data that is available from the National Resources Conservation Service (NRCS) in the United States. Typically, soil survey data is available on a county-by-county basis within each state. Although the scale of soil surveys may vary from county to county, the latest soil survey maps are available in typical scales of 1:12000 or 1:24000. The Natural Resources Conservation Services (NRCS) National Cartographic Center may provide soil maps, text, tables, and spatial data in various text data formats, digital formats, shape files, and other file formats or data structures.

If the soil survey data from government sources does not offer sufficient resolution (e.g., 1 m to 5 m resolution is typical) or if soil survey data in multiple spatial dimensions, commercially available soil surveyors or soil surveying services may collect a database of soil data for a grower, an insurer, or both. Soil survey data may be defined in terms of soil parameters that can affect the performance or growth of a crop.

The soil survey data may include, but is not limited to, the following soil parameters: soil texture, sand content, silt content, clay content, soil structure, bulk density, soil organic matter content, soil moisture, water holding capacity, available water capacity, nitrogen (N) level, posphorus (P) level, potassium (K) level, nutrient levels, micronutrient levels, trace element levels, mineral levels, soil pH (e.g., level of acidity or alkalinity), and cation-exchange capacity. The available water capacity is the capacity of a soil to hold water available for plants. The available water capacity may be expressed as inches of water per a certain soil depth.

In one configuration, the weather and climate data source 30 comprises a server, a database management system, or another data processing system. The weather and climate data source 30 makes available or provides weather data or climate data available from a governmental or nongovernmental entity. For instance, the weather and climate data may comprise data that is available through the National Oceanic and Atmospheric Administration, the U.S. Department of Agriculture, the National Drought Mitigation Center or other sources. Climate data refers to data on expected long-term weather patterns. Predictive climate data may be based on historical data. Climate data may include precipitation (e.g., rainfall per unit time or rainfall per date of the year), degree days, growing degree days, winds, and temperature statistics for a corresponding geographic area. The temperature statistics may include a minimum temperature, a maximum temperature, a mean temperature, and a mode temperature for a corresponding geographic area. The growing degree day and degree day are both based on temperature statistics. The growing degree day is an index that may be used to express or predict crop maturity. The growing degree day may be based on the minimum and maximum temperature for a day with respect to a reference temperature (e.g., 50 degrees for a corn growing degree day) for a corresponding geographic location. A degree day is used to estimate the amount of energy required to maintain a comfortable target indoor temperature in a certain geographic area. A degree day represents that extent that the daily mean temperature falls below or above an indoor target temperature (e.g., 65 degrees).

Climate data may be used to determine or estimate an average growing season duration for a corresponding geographic area, growing zones suitable for particular crops (e.g., based on the genetic composition of those crops), temperature range zones, or other climate classifications for corresponding geographic areas (e.g., geographic zones) that are useful for agronomic management, crop selection, planting dates, and crop maturity estimation.

Weather data refers to forecasted, current, or historic data concerning the weather associated with a geographic area (e.g., geographic zones) or location. Weather data may be time stamped, and date stamped. The weather data may include measurements and statistics related to temperature, precipitation, sunlight (e.g., visible or ultraviolet light intensity versus time or cumulative light exposure), cloud cover, wind speed, wind direction, and barometric pressure, for instance.

The weather data may be used to provide a drought assessment or drought report for a corresponding geographic location or area (e.g., geographic zone). A drought refers to a deficiency of precipitation resulting from a short term or long-term weather pattern. The drought bay be defined with reference to a drought severity index (e.g., Palmer Drought Severity Index, the Crop Moisture Index, and the Z index). A weather forecast may be used to determine the probability of ending or reducing the severity level of a drought in a given geographic area.

The historic yield data source 34 may comprise publicly available data such as the yield data that is available on a crop-by-crop basis for various counties. For instance, the historic yield data may comprise county yield data of the National Agricultural Statistics Database.

The grower data source 32 may comprise a grower personal computer, a grower terminal, or an insurance agent terminal that communicates with the data processing system 12 via the communications network 22. For example, a grower terminal may access the Internet via an internet service provider (ISP) to complete or submit an application for a crop insurance policy or endorsement to another crop insurance policy. The grower may provide grower data to the data processing system 12 via the application, via an electronic interview process, or otherwise. Similarly, the grower may in person or via a telecommunications network (e.g., telephone network) provide data to an insurance agent or insurance worker who enters the data into the data processing system 12.

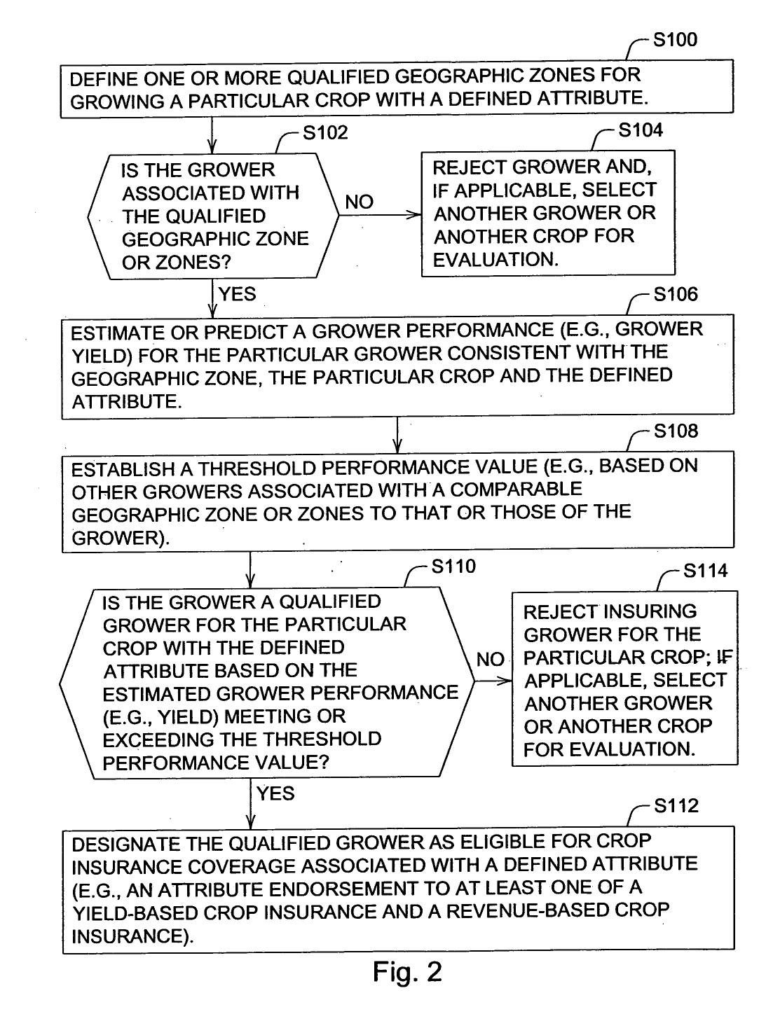

FIG. 2 illustrates a method for providing crop insurance. The method of FIG. 2 begins in step S100.

In step S100, a zone definer 14 defines one or more qualified geographic zones for growing a particular crop associated with a defined attribute. In general, each qualified geographic zone is selected to be generally suitable for growing the particular crop based one or more of the following: genetic factors for a particular crop, environmental factors for the corresponding zone, and historic performance (e.g., historic yield data) of growers of the particular crop within the geographic zone. The genetic factors (e.g., date to maturity or duration from planting date to harvest date) for the particular crop may impact whether or not a particular crop is suitable for growing in a particular geographic zone. For instance, a particular crop may be qualified for a corresponding geographic zone because the length of a growing season or growing degree days meets or exceeds a minimum duration. Grower data may provide information on the genetic profile of a particular crop or other genetic factors (e.g., drought tolerance), for instance. Environmental factors may include soil data, weather data, and climate data, among other things. With respect to climate data or weather data, a particular crop with above average drought tolerance may be favored for a corresponding geographic zone with less rainfall than required by similar crops with average or below average drought tolerance.

In step S102, the evaluator 18 or data processing system 12 determines if the grower is associated with the qualified geographic zone or zones. The grower may provide his street address, county, geographic coordinates, or reference to a legal description of his property to determine what zone or zones the grower's land falls within. If the grower is associated with the qualified geographic zone or zones, the method continues with step S106. However, if the grower is not associated with the qualified geographic zone or zones, the method continues with step S104.

In step S104, the evaluator 18 or data processing system 12 rejects the grower and (if applicable) (a) selects another grower for evaluation to determine of the grower's field or fields lie within qualified geographic zone or zones, or (b) selects another crop (e.g., different particular crop with a different or similar defined attribute) of the grower for evaluation.

In step S106, the performance predictor 16 or data processing system 12 estimates or predicts a grower performance for a particular grower consistent with the geographic zone, the particular crop and the defined attribute. For example, the performance predictor 16 estimates or predicts a grower yield for a particular grower consistent with the geographic zone, the particular crop and defined attribute based on genetic, environmental, and management factors.

The prediction of the performance of a grower growing a crop with a specific attribute may be carried out in accordance with several techniques, which may be applied alternatively or cumulatively. Under a first technique, the performance predictor 16 or data processing system 12 estimates the grower performance or grower yield based on one or more of the following: defining the genetic characteristics of the particular crop, assessing management practices of the grower, and reviewing historic yields of the grower for substantially similar crops in the geographic zones. The management practices of a grower may be rated based on one or more of the following: (1) use of low-till or no-till farming operations to reduce soil erosion or loss of applied nutrients during the growing season, (2) use of buffer zones or filter strips to reduce soil erosion or loss of applied nutrients during the growing season, (3) use of crop rotations to reduce pesticide requirements (e.g., dosage or application rates) over a multi-year time span, (4) use of legumes to enrich soil with nitrogen for subsequent crops (e.g., corn or wheat), (5) the use of organic growing practices (e.g., consistent with the Organic Food Production Act of 1990, 7 U.S.C.§§ 6501-6522), (6) use of buffer zones (e.g., one mile zone) around the particular crop to prevent cross-pollination or contamination (e.g., lack of purity) of defined attributes from adjacent fields growing different varieties of crops, and (7) use of dedicated harvester, combine, pickers, or other harvesting machinery and storage facilities to avoid cross-contamination of the particular crop (e.g., pharmaceutical grade corn) with other crops (e.g., commodity crops). For instance, organic growing practices may prohibit the use of synthetic chemicals during a growing season and for three (3) years immediately preceding the harvest of agricultural products, unless an exception applies under applicable law or regulations. Further organic growing practices may require buffer zones between organically cultivated land and land that is not cultivated in accordance with organic operations.

Under a second technique, the performance predictor 16 determines whether a particular grower's land is associated with more than one geographic zone distinguished by different soil characteristics, different weather characteristics, or both. If the particular grower's land is associated with more than one geographic zone, the performance predictor 16 applies multiple geographic zones to estimate the yield for a particular crop with a crop attribute grown across multiple geographic zones.

Under a third technique, the performance predictor 16 determines whether the particular grower's land is geographically distributed (e.g., among multiple geographic zones) in such a manner to reduce risk of growing the crop with a particular defined attribute. If the grower's land is geographically distributed, the variance of the yield may be reduced in accordance with empirical studies or historical field measurements relating or correlating distributed production to reduced production variance for a particular crop.

In step S108, a data processing system 12 or an evaluator 18 establishes a threshold performance value to judge the growing or planned growing of the particular crop in the qualified geographic zone or zones. For example, the threshold performance value may be established based on an average historic performance, a mode historic performance or both of other growers associated with a comparable geographic zone or zones (e.g., farms within the same county) to that or those of the grower. Further, the threshold performance may include supplemental criteria based on the standard deviation or other measure of variability of the mean or mode historic performance. In one configuration, the threshold performance value is based on historical yields of growers of particular crops (e.g., the same or substantially similar crops) in the same county as the particular grower. In another example, the threshold performance value may be based on grower in the same county with a substantially similar zone or zone composition to the subject grower, as opposed to more general county historical yields. In yet another example, the threshold performance is based on historic performance or yield associated with the particular crop growing in a suitable zone or zones for the particular crop. Although step S108 is shown as following step S106, in practice steps S106 and S108 may be carried out in any order or simultaneously.

In step S10, a data processing system 12 or an evaluator 18 determines whether the grower qualifies for the status of a qualified grower for a particular crop with the defined attribute based on the estimated grower performance (e.g., grower yield) meeting or exceeding the threshold performance value. If the estimated grower performance meets or exceeds the threshold performance value, the method continues with step S112. However, if the estimated grower performance does not meet or exceed a threshold value, the method continues with step S114.

In step S112, an evaluator 18 designates the qualified grower as eligible for crop insurance coverage (e.g., crop insurance policy or endorsement) associated with a defined attribute. For example, the crop insurance coverage may comprise an attribute endorsement to at least one of a yield-based crop insurance and a revenue-based crop insurance. In one example, the yield-based crop insurance comprises Multiple Peril Crop Insurance (MPCI). In another example, the revenue-based crop insurance Crop Revenue Coverage (CRC) as the revenue-based crop insurance. In still another example, the yield-based crop insurance comprises Group Risk Insurance.

In the U.S., the multiple Peril Crop Insurance (MPCI) program protects against yield risk. Yield risk tends to be affected by natural disasters, for instance. The desired level of protection may be based upon a percentage of a particular grower's historic yield. The grower's historic yield may be defined in terms of a grower's actual production history (APH). Catastrophic Risk Protection (CAT) is generally the lowest level of MPCI coverage. MPCI and other policies based on APH may have the following coverage exclusions: (1) hail and fire exclusion provisions and (2) high risk land exclusion provisions. MPHCI and other policies based on APH may also have the following coverage requirements or limitations: (1) late planting provisions, (2) replant requirements, (3) replanting payment provisions, (4) prevented planting provisions, (5) nonstandard classification system, and (6) experience adjustment factors.

A gap policy, called crop-hail insurance, can fill the gap for damage that is less than the deductible of a basic MPCI policy. Crop-hail insurance may provide acre-by-acre coverage against hail damage, whereas certain MPCI coverage may only protect against widespread hail damage that materially effects a grower's overall yield.

In the U.S., the Crop Revenue Coverage (CRC) program protects against both yield and price risk to facilitate the insured grower earning a minimum revenue. The protection of the yield is based on using a particular grower's actual production history (APH).

Group Risk Protection (GRP) is generally similar to the MPCI program, except that the county yield or geographic region yield is used, instead of the individual grower's historic yield. GRP is a risk management tool that is an alternative to the MPCI or other crop insurance based on Actual Production history. The GRP may be used by growers with yields that tend to track the county yield and where a drought or other natural disaster tends to affect a substantial portion of a county. GRP indemnifies or pays out the insured grower if the county average per acre yield (referred to as the “payment yield”) falls below the insured grower's trigger yield. The Federal Crop Insurance Corporation (FCIC) may publish or disclose the payment yield to insurance providers for each county, following each growing season or crop year, or otherwise. The trigger yield means the expected county yield listed in the actuarial document multiplied by the coverage level percent listed on the accepted application. The expected county yield may represent an average of annual NASS county yields adjusted for yield trends. The grower may select a coverage level of from approximately sixty percent to approximately one hundred percent (or a lesser applicable maximum percentage) of the maximum protection per acre. Unless allowed by the GRP policy, the insured grower cannot insure the same crop through both an MPCI policy and GRP policy. A grower is not required to maintain or report yield history for GRP policies. For a GRP policy, a grower may have a low yield on his farm and not receive a payment under the GRP policy because the policy is based on county yields, not individual grower yields.

In step S114, the data processing system 12 or evaluator 18 rejects the grower with respect to insuring or covering the particular crop with the defined attribute. However, the rejection of the grower does not necessarily equate to a rejection of the grower for all crops with defined attributes. If applicable, the data processing system 12 or insurer may select another grower or may evaluate another particular crop (e.g., a suitable substitute or replacement) with an initially rejected grower. The subsequently evaluated particular crop may have the same, similar, or different defined attributes with respect to the initially evaluated particular crop.

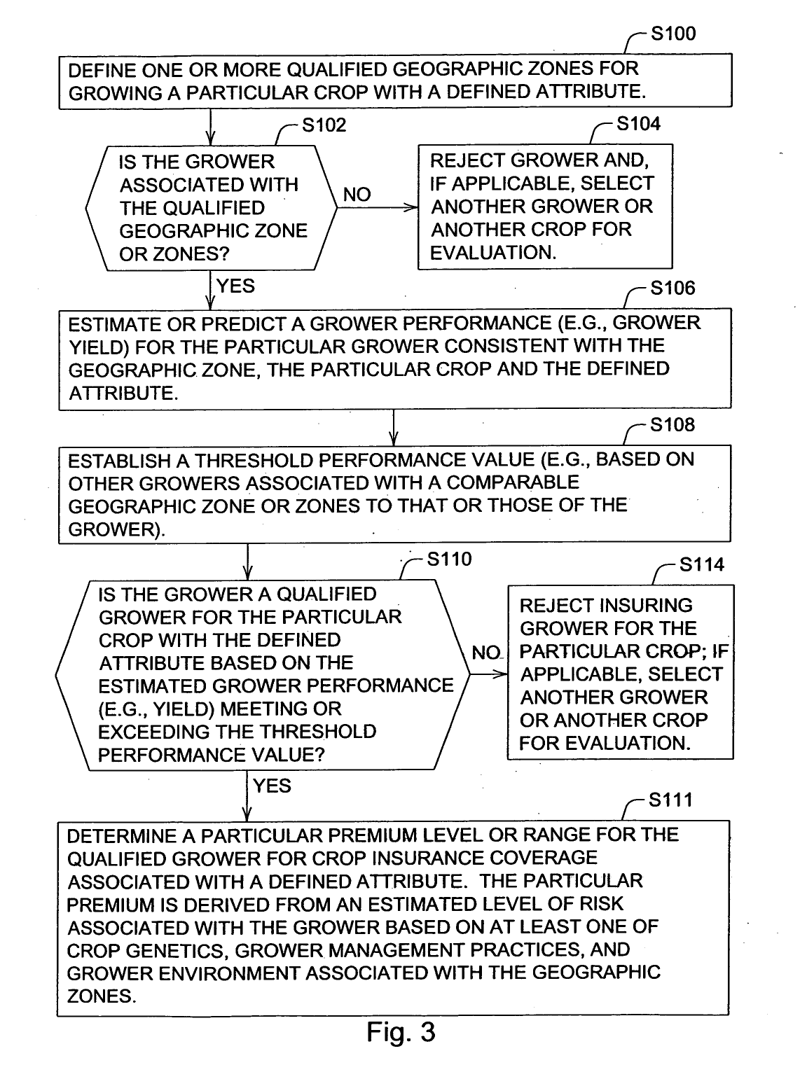

The method of FIG. 3 is similar to the method of FIG. 2, except step S112 of FIG. 2 is replaced with step S111 of FIG. 3. Like reference numbers in FIG. 2 and FIG. 3 indicate like procedures or steps.

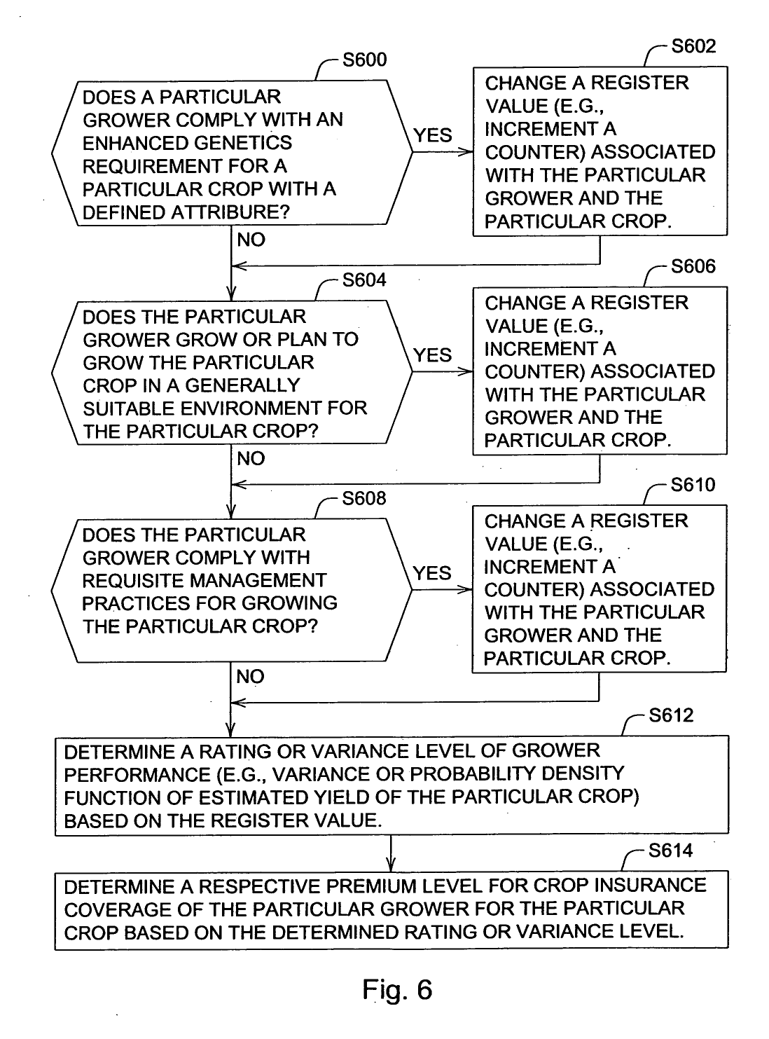

In step S111, a data processing system 12 determines a particular premium level or range for the qualified grower for crop insurance coverage associated with a defined attribute (e.g., an attribute endorsement to at least one of yield-based crop insurance and a revenue-based crop insurance). The particular premium is derived from an estimated level of risk associated with the grower based on at least one of the crop genetics, grower management practices, and grower environment associated with geographic zones. The method of FIG. 6, which is described later, provides a detailed explanation on determination of a premium level or premium range for insurance coverage.

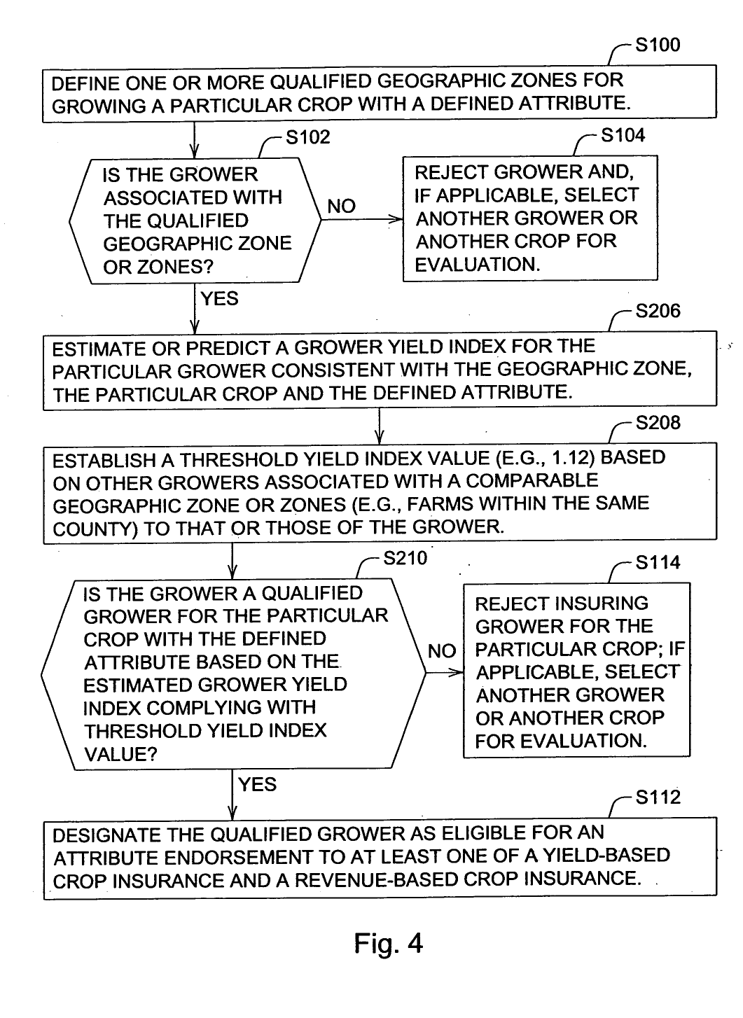

The method of FIG. 4 is similar to the method of FIG. 2, except steps S106, S108 and S110 of FIG. 4 are replaced with steps S206, S208 and S210, respectively. Like reference numbers in FIG. 2 and FIG. 4 indicate like procedures or steps.

In step S206, the performance predictor 16 or data processing system 12 estimates or predicts a grower yield index for the particular grower consistent with geographic zone, the particular crop, and the defined attribute. For example, the performance predictor 16 determines a yield index for the grower based on the geographic zones (e.g., qualified geographic zones) in which the grower is located. In general, the yield index may comprise a ratio of predicted grower yield data to historical grower yield data for a geographic zone (e.g., qualified geographic zone). In one example, the historical grower yield data divided by predicted grower yield data for a particular crop within a particular zone. That is, the yield index may be determined in accordance with the following equation: Y_{I}=Y_{H}/Y_{P}, Y_{I} is the yield index, Y_{H} is the historical grower yield data for a particular crop (or a substantially similar crop) in the particular zone and Y_{P} is the predicted grower yield data for the particular crop in the zone. The historical grower data and predicted grower yield data may represent an average or mean per land unit (e.g., acre) yields. Where the yield index is Y_{H}/Y_{P}, a lower yield index indicates better performance of the grower and a yield index.

In step S208, the evaluator 18 or data processing system 12 establishes a threshold yield index value based on other growers associated with a comparable geographic zone or zones (e.g., farms in the same county) to that or those of the grower. The threshold yield index value may be based on a reference value of the yield index that reflects a minimum performance standard (e.g., above average performance of a grower for a county, region, or crop type). For instance, the reference value may be selected within a range of five (5) to fifteen (15) percent above an average or mean county yield, above an average or mean yield for a corresponding geographic region (e.g., qualified geographic zone), or with reference to the variance of standard deviation of yields with the corresponding geographic region.

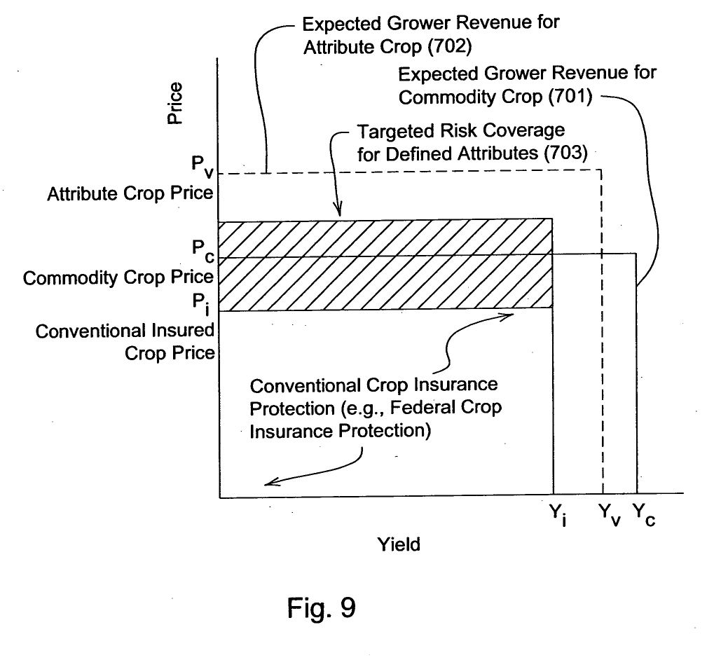

Depending upon the identity or characteristics of the defined attribute, a particular crop with a defined attribute may or may not have a lower predicted yield than the yield of a corresponding closest commodity crop. In one example, a noncompliant yield amount of the harvested crop may not meet a defined specification consistent with the defined attribute; the noncompliant amount may be deducted from the gross yield to determine a net yield of the crop having the defined attribute. The grower may be compensated from the purchaser based on the net yield, as opposed to the gross yield. The noncompliant amount of the harvested crop may or may not comply with standards of merchantability or sale as a commodity crop. In another example, if the yield is contractually tied to an agricultural product or derivative product derived from harvested crop, the defined attribute yield is distinct from the harvested crop yield, but may be proportional to or correlated with respect to the harvested crop yield. In another example, where the defined attribute represents organic produce or meat, the yield of the organic produce or meat is not necessary lower than that of conventional produce or meat. Although step S208 follows step S206 in FIG. 9, step S206 and step S208 may be executed in any order with respect to each other, or even simultaneously.

In step S210, the evaluator 18 or data processing system 12 determines whether the grower is qualified grower for the particular crop with the defined attribute based on the estimated grower yield index meeting or exceeding the threshold yield index value. For example, if the yield index is defined as the historical grower yield data divided by the predicted grower yield data, and if the grower yield index is less than the threshold index value of the yield index, the method continues in step S112. However, if the grower yield index does not comply with the threshold yield index, the method continues with step S114.

In step S112, the grower is qualified or eligible to obtain coverage under the supplemental attribute insurance or other crop insurance policy associated with a defined attribute.

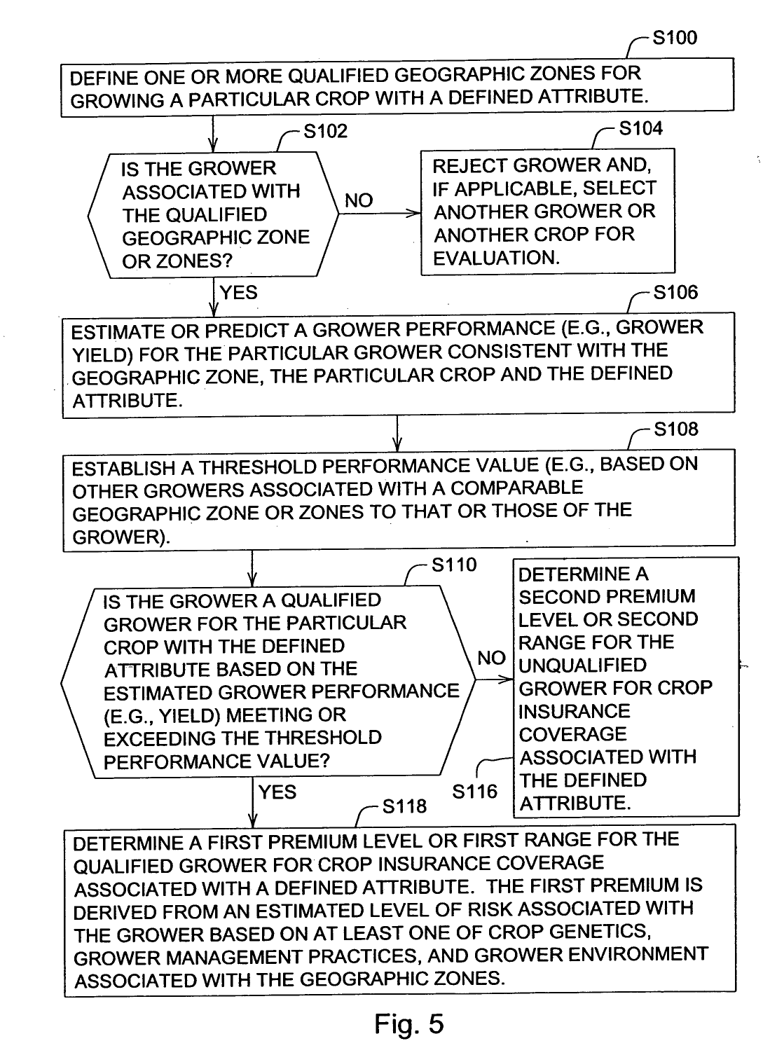

The method of FIG. 5 is similar to the method of FIG. 3, except steps S111 and step S114 are replaced by steps S118 and S116, respectively. Like reference numbers in FIG. 5 and FIG. 3 indicate like procedures or steps.

In step S110 of FIG. 5, a data processing system 12 or an evaluator 18 determines whether the grower qualifies for the status of a qualified grower for a particular crop with the defined attribute based on the estimated grower performance (e.g., grower yield) meeting or exceeding the threshold performance value. If the estimated grower performance meets or exceeds the threshold performance value, the method continues with step S118. However, if the estimated grower performance does not meet or exceed a threshold value, the method continues with step S116.

In step S118, a data processing system 12 determines a first premium level or first range for the qualified grower for crop insurance coverage associated with the defined attribute. The first premium level may be based on an estimate level of risk associated with the grower based on at least one of the crop genetics, grower management practices, and grower environment associated with the geographic zones. The method of FIG. 6, which is described later, provides a detailed explanation of determining premium level or premium ranges.

In step S116, a data processing system 12 determines a second premium level or a second range for the grower (e.g., the unqualified grower) for crop insurance coverage associated with the defined attribute. For example, the second premium for a crop insurance policy may be greater than a first premium for the same or substantially equivalent crop insurance policy. The first risk associated with the qualified grower for growing a particular crop may be less than the second risk associated with an unqualified or less qualified grower. Further, the grower may be unqualified or less qualified because of its management practices or any other factor that contributes to noncompliance with a threshold performance value in accordance with applicable laws and regulations.

FIG. 6 discloses a method for determining a rating or variance level of a particular grower that may be applied to any method of providing crop insurance disclosed hereunder, including those set forth in FIG. 2 through FIG. 5, inclusive. The method of FIG. 6 may be used to set an appropriate premium level or premium range (for insurance coverage) that corresponds to the variance level associated with estimated grower performance. The method of FIG. 6 begins in step S600.

In step S600, a data processing system 12 or evaluator 18 determines whether or not a particular grower complies with an enhanced genetics requirement for a particular crop with a defined attribute. The enhanced genetics requirement may comprise using plants or seeds (e.g., certified seeds) with a certain genetic make-up or a particular gene sequence inserted or otherwise brought into the deoxyribonucleic acid (DNA) of seed, plant tissue, embryo, or plant cell that is (a) associated with adequate expression of the defined attribute, (b) proven to perform reliably in field trials, tests, or through sufficient historic records of use and (c) sufficiently compatible with the environment (e.g., soil, weather and climate) of the geographic zone or zones in which the crop is grown. If the particular grower complies with the enhanced genetics requirement, the method continues with step S602. However, if the particular grower does not comply with the enhanced genetics requirement the method continues with step S604.

In step S602, the data processing system 12 changes a register value associated with the particular grower and the particular crop. For example, a counter is incremented that is associated with the particular grower and the particular crop, where a higher aggregate register value (e.g., counter value) represents greater compliance with one or more agronomic factors or lesser variance in grower performance. Alternately, the counter may be decremented, where a lower aggregate register value represents greater compliance with one or more agronomic factors or lesser variance in grower performance. Step S604 may be executed after step S602, as indicated in FIG. 6.

In step S604, the data processing system 12 or the evaluator determines whether the particular grower grows (or plans to grow) the particular crop in a generally suitable environment for the crop. For example, the data processing system 12 or evaluator 18 may determine if the grower is associated with a qualified geographic zone or zones for growing a particular crop with a defined attribute. Regardless of whether the enhanced genetics requirement is satisfied or not, the qualified geographic zone may consider the soil, weather, climate, planned planting date, planned harvest date, and growing degree days, among other agronomic information in step S604. The grower may provide information on the geographic coordinates of the fields to be used for growing the particular crop or other location data (e.g., a street or mailing address of a farm, a state and county location, or the nearest main roads) to register or align a location of a particular grower with corresponding applicable soil, weather and climate data. If the particular grower grows or plans to crop the particular crop in a generally suitable environment, the method continues with step S606. However, if the particular grower is noncompliant with respect to a generally suitable environment for the particular crop, the method continues with step S608.

In step S606, the data processing system 12 changes a register value associated with the particular grower and the particular crop. For example, a counter is incremented that is associated with the particular grower and the particular crop, where a higher aggregate register value (e.g., counter value) represents greater compliance with one or more agronomic factors or lesser variance in grower performance. Alternately, the counter may be decremented, where a lower aggregate register value represents greater compliance with one or more agronomic factors or lesser variance in grower performance. Step S608 may be executed after step S606, as indicated in FIG. 6.

In step S608, the data processing system 112 determines whether a particular grower complies with the requisite management practices for growing the particular crop. The requisite management practices may stem from actual or anticipated contractual requirements associated with a purchaser or potential purchaser of the particular crop associated with the defined attribute. Alternatively, the requisite management practices may be based on best management practices, scientific research, conventions, norms, regulations, laws, certifications or standard industry or agricultural practices in absence of actual or anticipated contractual requirements. The management practices may be audited (remotely or in person) during the growing season as a condition of continued coverage under any insurance policy or crop insurance coverage issued, for example. If the particular grower complies with the requisite management practices, the method continues with step S610. However, if the particular grower is noncompliant with respect to requisite management practices for the particular crop, the method continues with step S612.

In step S610, the data processing system 12 changes a register value associated with the particular grower and the particular crop. For example, a counter is incremented that is associated with the particular grower and the particular crop, where a higher aggregate register value (e.g., counter value) represents greater compliance with one or more agronomic factors or lesser variance in grower performance. Alternately, the counter may be decremented, where a lower aggregate register value represents greater compliance with one or more agronomic factors or lesser variance in grower performance. Step S612 may be executed after step S610, as indicated in FIG. 6.

In step S612, a data processing system 12 determines a rating or variance level of grower performance (e.g., variance or probability density function of estimate yield of the particular crop) based on the register value. In one example, if the register value (or aggregate register value) is incremented or increased (e.g., by a weighted or unweighted amount) during any of the steps S602, S606 and S610, the higher register value (e.g., counter value) represents one or more of the following: greater compliance with one or more agronomic factors, a higher grower rating, lesser variance in grower performance, and a lower premium level, and a lower premium range. In contrast, if the register value (or aggregate register value) is decremented or decreased (e.g., by a weighted or unweighted amount) during any of the steps S602, S606 and S610, the lower register value (e.g., counter value) represents one or more of the following: greater compliance with one or more agronomic factors, a higher grower rating, lesser variance in grower performance, and a lower premium level, and a lower premium range.

In step S614, a data processing system 12 determines a respective premium level for crop insurance coverage of the particular grower for the particular crop based on the determined rating or variance levels. Step S614 may be carried out in accordance with various techniques that may be applied independently or cumulatively. Under a first technique, if the register value (or aggregate register value) is incremented or increased (e.g., by a weighted or unweighted amount) during any of the steps S602, S606 and S610, a highest register value is associated with a lowest premium level or lowest premium range; an intermediate register value is associated with an intermediate premium level or intermediate premium range; and a lowest register value is associated with a highest premium level or highest premium range.

Under a second technique, if the register value (or aggregate register value) is decremented or decreased (e.g., by weighted or unweighted amount) during any of the steps S602, S606 and S610, a highest register value is associated with a highest premium level or first premium range; an intermediate register value is associated with an intermediate level or intermediate premium range; and a lowest register value is associated with a lowest premium level or lowest premium range.

Under a third technique for carrying out step S614, the data processing system 12 may store a look-up table, a chart, a database, or another file or group of records that contains respective premium levels associated with corresponding ratings or variance levels. For example, the look-up table, chart, database or file may assign a lowest premium level to a corresponding lowest variance level, an intermediate premium level to a corresponding intermediate variance level, and may assign a highest premium level to the highest variance level.

Under a fourth technique, the data processing system 12 may calculate a respective premium level based on an equations or formula that has a variance level as a factor, such that the lower the variance level the lower the premium level and the higher the variance level the higher the premium level.

Under a fifth technique, step S612 and step S614 are merged or integrated into a single step procedure in which there is a direct relationship between register value and a corresponding premium range or level, as opposed to a first relationship between a register value and a variance level of step S612 and a second relationship between a variance level and a corresponding premium range or level as in step S614.

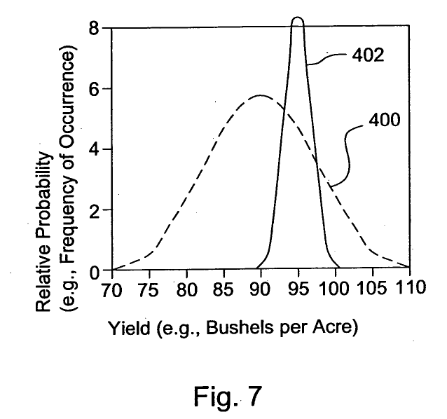

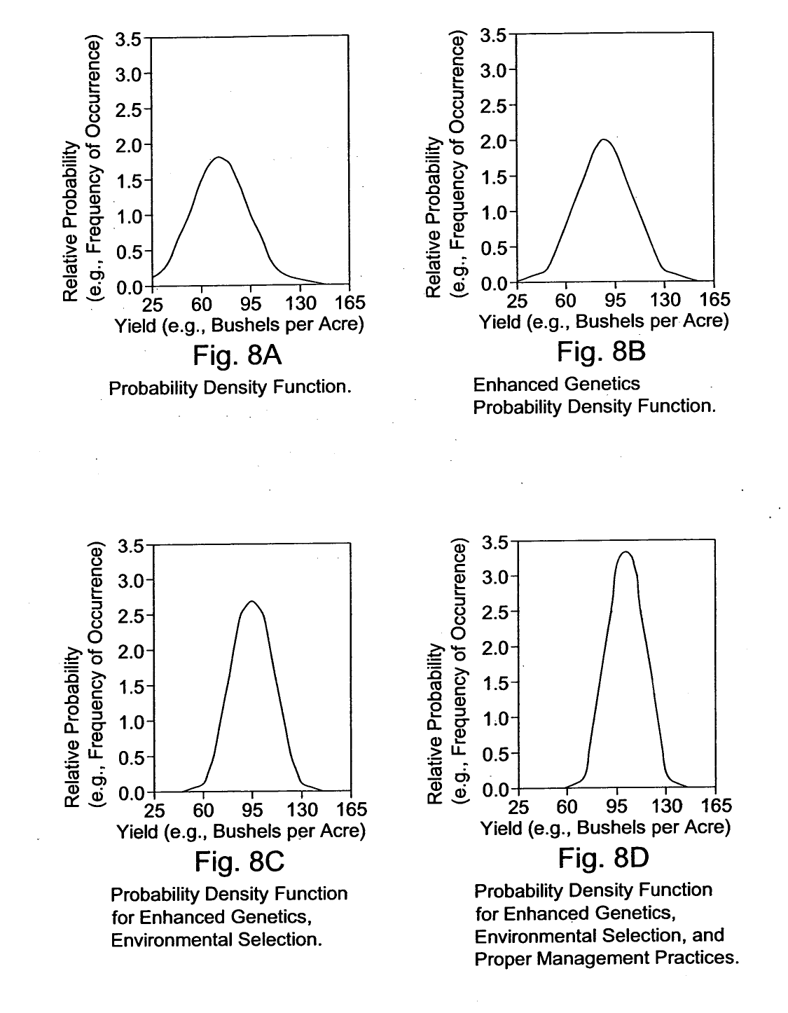

In FIG. 7, the graph shows yield distributions or variances for a particular crop with respect to a first grower and a second grower or group of growers. The variance may represent variances in yield over a certain number of growing seasons or years or the probability of achieving a given yield in any single year. The first yield distribution 402 is shown as a solid curved line, whereas the second yield distribution 400 is shown as a dashed curved line. The horizontal axis shows a yield and the vertical axis shows a probability (or frequency of occurrence over a defined time interval) of the yield. The first yield distribution 402 has a lesser variance than the second yield distribution 400 does. If the first grower has a first yield distribution 402 or variance for the particular crop, an insurer may regard the first grower as lower risk or within a lower premium schedule. In contrast, the insurer may regard the second grower or group of growers as higher risk, consistent with a higher premium schedule for coverage comparable to that of the first grower. If variance data or yield distributions are available for a grower, such data may be applied to determine a premium. However, if the variance or yield distributions may be affected by various factors as illustrated in FIG. 8A through FIG. 8D, inclusive.

In each chart or graph in FIG. 8A through FIG. 8D, the vertical axis represents probability (or frequency of occurrence) and a horizontal axis represents yield of a particular crop with a defined attribute.

In FIG. 8A, the baseline yield distribution is shown for a grower that may grower crops with improper genetics, a suboptimal environment, or with poor agronomic or management practices. In FIG. 8B, an enhanced-genetics yield distribution is shown where the proper genetics are selected, but the environment remains suboptimal and the grower applies poor management practices. An insurance policy (associated with a defined attribute) or endorsement may include genetic requirements for seed or plants to reduce the variance of a crop attribute of the particular crop and minimize the risk to the insurer. The first variance level or range of the enhanced-genetics yield of FIG. 8B is less than the baseline yield distribution of FIG. 8A. The first variance level or range of FIG. 8B may correspond to the assignment of a primary premium level (lower than a baseline premium level) consistent with the method of FIG. 6, or otherwise.

In FIG. 8C, enhanced genetics and an enhanced environment is selected for growing a particular crop, but the grower management practices are deficient or inconsistent in some material respect. The insurance policy (associated with a defined attribute) or endorsement may include environmental requirements, such as soil characteristics, rainfall temperature, and climate. The second variance level or range of FIG. 8C may correspond to the assignment of a secondary premium level (lower than a baseline premium level and the primary premium level) consistent with the method of FIG. 6, or otherwise.

The variance of the yield distribution of FIG. 8C is less than that of FIG. 8B. In FIG. 8D, enhanced genetics, an enhanced environment, and enhanced grower management practices are selected for growing a particular crop. For example, the enhanced grower management practices may call for irrigation, application of certain crop inputs (e.g. pesticides, insecticides, fungicides) with defined dosages at particular times. The variance of the yield distribution of FIG. 8D is less than that of FIG. 8C. The third variance level or range of FIG. 8D may correspond to the assignment of a tertiary premium level (lower than a baseline premium level, the primary premium level, and the secondary premium level) consistent with the method of FIG. 6, or otherwise.

FIG. 9 illustrates the targeted risk coverage of crop insurance or an endorsement for covering a crop attribute. The vertical axis shows the market price for a particular crop and the horizontal axis shows the yield. On the vertical axis, the conventional insured crop price (Pᵢ) is lower than the commodity crop price (P_{c}). The conventional insured crop price (Pᵢ) may represent the federally insured crop price, for example. The attribute crop price (Pᵥ) is higher than both the commodity crop price (P_{c}) and the conventional insured crop price (Pᵢ). On the horizontal axis, conventional insured yield (Yᵢ) is lower than the commodity crop yield (Y_{c}) and the attribute crop yield (Yᵥ). Although the attribute crop yield is lower than the commodity crop yield, in an alternative examples the attribute yield may be greater than or equal to the commodity crop yield.

The conventional crop insurance provides protection against a risk of loss for grower for a conventional insured crop price at a corresponding conventional insured yield. Accordingly, for an insured grower that falls within the terms of the conventional crop insurance policy, the payment for a protected or covered loss may be equal to the insured crop price multiplied by the insured crop yield. The expected grower revenue from a commodity crop is shown by the rectangular region 701. The expected grower revenue for the attribute crop is shown by the rectangular region 702. However, if the commodity crop price and commodity yield are greater than the conventional insured crop price and conventional insured yield, there is a coverage gap between the conventional crop insurance and the actual damage or loss that the grower suffers. Aside from the potentially lower yield from certain crops with certain defined attributes, the coverage gap is generally even greater for crop with a defined crop attribute because the attribute crop price is generally greater than the commodity crop price. The grower may not receive the attribute crop price unless the attribute crop (with the defined attribute) substantially or fully conforms to desired attribute specifications. The cross hatched rectangular 703 region in FIG. 7 represents an illustrative example targeted risk coverage for a crop insurance that covers an attribute crop.

Having described the preferred embodiment, it will become apparent that various modifications can be made without departing from the scope of the invention as defined in the accompanying claims.

We claim:

1. A method for providing crop insurance for a crop associated with a defined attribute, the method comprising:
evaluating a grower to determine whether the grower is associated with a qualified geographic zone or zones for growing a particular crop with a defined attribute;
estimating or predicting a grower performance for the particular grower consistent with the geographic zone and defined attribute;
determining if the grower is a qualified grower for the particular crop with the defined attribute based on the estimated grower performance meeting or exceeding a threshold value; and
designating the qualified grower as eligible for insurance coverage associated with the defined attribute.

2. The method according to claim 1 wherein the grower performance comprises an estimated grower yield.

3. The method according to claim 1 wherein the grower performance comprises a yield index comprising a ratio of predicted grower yield data to historical grower yield data for the geographic zone

4. The method according to claim 1 wherein the grower performance comprises a yield index; the yield index being determined in accordance with the following equation: Y_{I}=Y_{H}/Y_{P}, where Y_{I} is the yield index, Y_{H} is the historical grower yield data for a particular crop in the particular zone and Y_{P} is the predicted grower yield data for the particular crop in the zone.

5. The method according to claim 1 wherein the threshold value is based on at least one of an average performance and a mode performance of other growers associated with one or more comparable geographic zone that are substantially similar to the qualified geographic zones.

6. The method according to claim 1 wherein the insurance coverage comprises at least one of an endorsement to a yield-based crop insurance and an endorsement to a revenue-based crop insurance.

7. The method according to claim 1 wherein the designating the grower as eligible comprises designating the grower as eligible for one or more of the following as the crop insurance: a Multiple Peril Crop Insurance, Crop Revenue Coverage, and Group Risk Insurance.

8. The method according to claim 1 wherein qualified geographic zone is selected based on at least one of soil characteristics, weather characteristics, and climate characteristics for the corresponding zone.

9. The method according to claim 1 wherein the estimating of the grower performance comprises defining genetic characteristics of the particular crop, assessing management practices of the grower, reviewing historic yields of the grower for substantially similar crops in the geographic zones.

10. The method according to claim 1 further comprising determining whether a particular grower's land is associated with more than one zone distinguished by different soil characteristics and different weather characteristics and applying multiple zones to estimate the yield for a crop grown across multiple zones.

11. The method according to claim 1 further comprising determining whether the particular grower's land is geographically distributed in such a manner to reduce risk of growing the crop with a particular attribute.

12. The method according to claim 1 further comprising:
determining a premium level for the qualified grower based on at least one crop genetics, grower management practices, and grower environment associated with the geographic zones.

13. The method according to claim 12 further comprising:
determining a rating or variance level for the particular grower based on a particular grower's compliance with an enhanced genetics requirement for a particular crop with a defined attribute, compliance with generally suitable environment for the particular crop, and compliance with requisite management practices for growing a particular crop; and
determining a respective premium level for crop insurance coverage of the particular grower for the particular crop based on the determined rating or variance level.

14. A method for providing crop insurance for a crop associated with a defined attribute, the method comprising:
evaluating a grower to determine whether the grower is associated with a qualified geographic zone or zones for growing a particular crop with a defined attribute;
estimating or predicting a grower performance for the particular grower consistent with the geographic zone and desired crop attribute;
determining if the grower is a qualified grower for the particular crop with the defined attribute based on the estimated grower performance meeting or exceeding a threshold value; and
determining a particular premium level or range for the qualified grower for insurance coverage associated with the defined attribute, the particular premium level derived from an estimating level of risk associated with the grower based on at least one of crop genetics, grower management practices, and grower environment associated with the geographic zones.

15. The method according to claim 14 wherein the grower performance comprises an estimated grower yield.

16. The method according to claim 14 wherein the grower performance comprises a yield index comprising a ratio of predicted grower yield data to historical grower yield data for the geographic zone

17. The method according to claim 14 wherein the grower performance comprises a yield index; the yield index being determined in accordance with the following equation: Y_{I}=Y_{H}/Y_{P}, where Y_{P} is the yield index, Y_{H} is the historical grower yield data for a particular crop in the particular zone and Y_{P} is the predicted grower yield data for the particular crop in the zone.

18. The method according to claim 14 wherein the threshold value is based on at least one of an average performance and a mode performance of other growers associated with one or more comparable geographic zone that are substantially similar to the qualified geographic zones.

19. The method according to claim 14 wherein the insurance coverage comprises at least one of an endorsement to a yield-based crop insurance and an endorsement to a revenue-based crop insurance.

20. The method according to claim 14 wherein the designating the grower as eligible comprises designating the grower as eligible for one or more of the following as the crop insurance: a Multiple Peril Crop Insurance, Crop Revenue Coverage, and Group Risk Insurance.

21. The method according to claim 14 wherein qualified geographic zone is selected based on at least one of soil characteristics, weather characteristics, and climate characteristics for the corresponding zone.

22. The method according to claim 14 wherein the estimating of the grower performance comprises defining genetic characteristics of the particular crop, assessing management practices of the grower, reviewing historic yields of the grower for substantially similar crops in the geographic zones.

23. The method according to claim 14 further comprising determining whether a particular grower's land is associated with more than one zone distinguished by different soil characteristics and different weather characteristics and applying multiple zones to estimate the yield for a crop grown across multiple zones.

24. The method according to claim 14 further comprising determining whether the particular grower's land is geographically distributed in such a manner to reduce risk of growing the crop with a particular attribute.

25. The method according to claim 14 wherein the determining the particular premium level comprises:
determining a rating or variance level for the particular grower based on a particular grower's compliance with an enhanced genetics requirement for a particular crop with a defined attribute, compliance with generally suitable environment for the particular crop, and compliance with requisite management practices for growing a particular crop; and
determining a respective premium level for crop insurance coverage of the particular grower for the particular crop based on the determined rating or variance level.

26. The method according to claim 25 wherein the determining of a variance level comprises determining at least one of a lowest variance level, an intermediate variance level and a highest variance level; and wherein the determining of the respective premium level comprises assigning a lowest premium level for the lowest variance level, assigning an intermediate premium level for the intermediate variance level, and assigning a highest premium level for the highest variance level.
